(19) United States
(12) Patent Application Publication
(10) Pub. No.: US 2019/0079489 A1
(43) Pub. Date: Mar. 14, 2019

(54) MACHINING SIMULATION APPARATUS

(71) Applicant: OKUMA CORPORATION, Niwa-Gun (JP)

(72) Inventors: Keishi NATSUHARA, Niwa-Gun (JP); Daichi TATEBE, Niwa-Gun (JP); Katsunori KUNIMITSU, Niwa-Gun (JP)

(73) Assignee: OKUMA CORPORATION, Niwa-gun (JP)

(21) Appl. No.: 16/113,172

(22) Filed: Aug. 27, 2018

(30) Foreign Application Priority Data
Sep. 14, 2017 (JP) 2017-176985
Jun. 15, 2018 (JP) 2018-114839

(51) Int. Cl. G05B 19/4069

(52) U.S. Cl. CPC G05B 19/4069; G05B 2219/42163

(57) ABSTRACT

A machining simulation apparatus performs a machining simulation in a machine tool by controlling a relative position between a tool model and a material model to perform a machining of the material model with the tool model. The machining simulation is performed with an input of at least one of a position command and a position detection value. The position command and the position detection value are obtained from the machine tool as log data corresponding to a time. A result of the machining simulation is displayed.

### BACKGROUND

This application claims the benefit of Japanese Patent Application Number 2017-176985 and Japanese Patent Application Number 2018-114839 filed on Sep. 14, 2017, the entirety of which is incorporated by reference.

### Technical Field

The disclosure relates to a machining simulation apparatus in a machine tool.

### Related Art

Japanese Unexamined Patent Application Publication No. 2009-116745 has disclosed a numerical control device that has a load information display function.

In this unit, load information stored corresponding to a block number of a machining program during an actual machining is displayed with a machining simulation that displays a state of cutting a workpiece by a tool corresponding to the block number.

The above-described numerical control device ensures confirming the state of cutting the workpiece and the load information for each block number of the machining program.

However, since the above-described numerical control device stores the load information corresponding to the block number of the machining program, the state of cutting the workpiece and the load information of a machining performed by manually operating a machine without using the machining program cannot be confirmed.

Therefore, a main object of the disclosure is to provide a machining simulation apparatus configured to reproduce an actual operating state of a machine tool not only for a machining using a machining program but also a machining performed by manually operating a machine.

### SUMMARY

In order to achieve the above-described object, there is provided a machining simulation apparatus according to a first aspect of the disclosure. The machining simulation apparatus performs a machining simulation in a machine tool by controlling a relative position between a tool model and a material model to perform a machining of the material model with the tool model. The machining simulation is performed with an input of at least one of a position command and a position detection value. The position command and the position detection value are obtained from the machine tool as log data corresponding to a time. A result of the machining simulation is displayed.

In the disclosure according to a second aspect of the above-described disclosure, at least any of a spindle load value, a feed axis load value, a spindle rotational speed, a temperature, a tool number, a sequence number of a machining program, and a starting command of the machining program obtained from the machine tool as the log data corresponding to the time may be displayed.

In the disclosure according to a third aspect of the above-described disclosure, the log data may be displayed in time series, and a range of a time for the machining simulation is specified based on an input to the display.

In the disclosure according to a fourth aspect of in the above-described disclosure, at least one of a block of the machining program and a manual operation history corresponding to the machining simulation may be displayed together.

A main effect of the disclosure is to provide a machining simulation apparatus configured to reproduce an actual operating state of a machine tool not only for a machining using a machining program but also a machining performed by manually operating a machine.

### BRIEF DESCRIPTION OF THE DRAWINGS

FIG. 1 is a block diagram illustrating a machining simulation apparatus of a machine tool according to the disclosure.

FIG. 2 is a drawing of a machine status information display window according to a log data display unit in FIG. 1.

FIG. 3 is a drawing of a result display window according to a machining simulation display unit in FIG. 1.

### DETAILED DESCRIPTION

The following describes embodiments and modification examples according to the disclosure based on the drawings as necessary. The disclosure is not limited to the embodiments and the modification examples below.

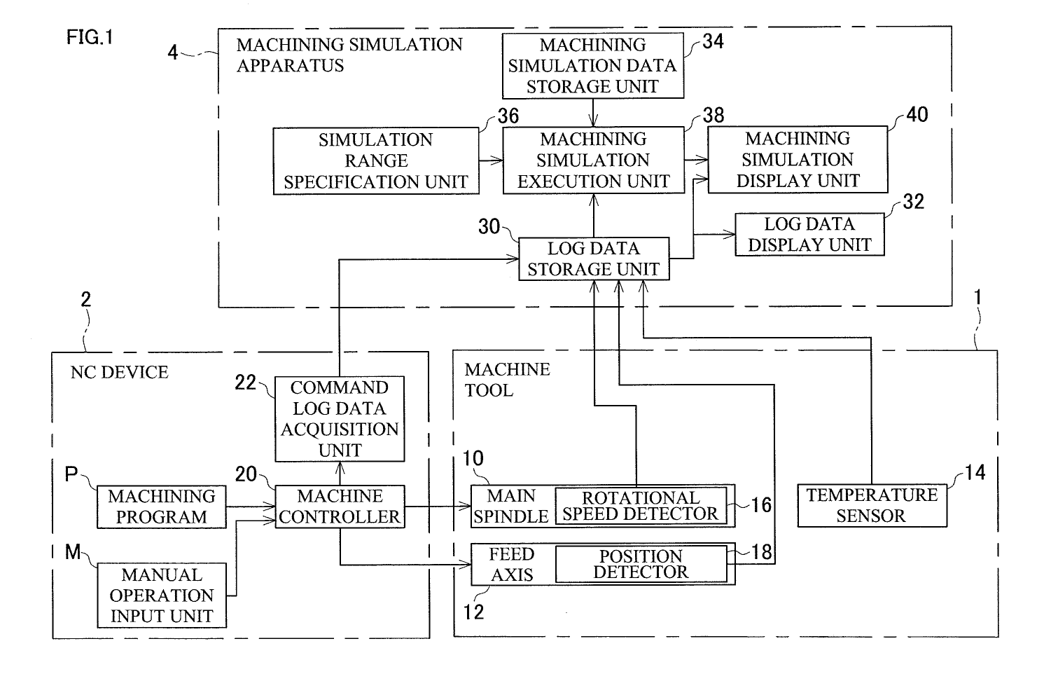

FIG. 1 is a block diagram illustrating a numerical control device (NC device) 2 that controls a machine tool 1, and a machining simulation apparatus 4 of the machine tool 1 according to the disclosure.

Here, the machine tool 1 is a five-axis-control machining center that has three axes of X, Y, and Z as mutually orthogonal linear axes and two axes of B and C as rotation axes. The machine tool 1 includes a main spindle 10 to which a tool is mounted, feed axes 12, a temperature sensor 14, and a tool changer (not illustrated). The feed axes 12 are disposed to the respective axes to change relative positions (at least one of changing positions by linearly moving and changing positions by rotational moving) between a tool and a workpiece (a material). The temperature sensor 14 is mounted to any position such as the main spindle 10 and senses a temperature of the mounted position.

The main spindle 10 includes a rotational speed detector 16 that detects a rotational speed of the main spindle 10.

The feed axes 12 include position detectors 18. Servomotors (not illustrated) are configured to move positions of the respective axes of X, Y, and Z and rotation positions of the respective axes of B and C. The respective servomotors include the position detectors 18. The position detectors 18 may be configured to directly detect positions of the main spindle 10 and the workpiece (a table).

The NC device 2 includes a machine controller 20 and a command log data acquisition unit 22. The machine controller 20 controls the main spindle 10 and the feed axes 12 based on inputs from a machining program P including a plurality of blocks or from a manual operation input unit M. The command log data acquisition unit 22 acquires command log data.

The machining program P includes one or more blocks to issue commands such as a move command of the feed axis 12, a rotation command of the main spindle 10, or a tool change command. The blocks are each provided with a sequence number as an identification code in sequence.

The manual operation input unit M is an input unit for manually operating the machine tool 1, and includes a manual feed button or a pulse handle for operating the feed axis 12, a spindle normal rotation button, a spindle reverse rotation button, and a spindle stop button for operating the main spindle 10, a tool change button for operating a tool change, and similar component. In the manual operation input unit M, a part of those components may be omitted.

The machine controller 20 sequentially interprets the blocks of the machining program P, and outputs specific commands to the main spindle 10, the feed axis 12, the tool changer, and the like at predetermined time points (here, for each predetermined control cycle) to control them. For example, the machine controller 20 outputs the position command, in which a route to a target position is divided for each control cycle, to the feed axis 12 for each control cycle corresponding to the move command of the feed axis 12. The machine controller 20 controls the main spindle 10 to rotate as the command corresponding to the rotation command. The rotation command of the main spindle 10 can include commands for specifying normal rotation, reverse rotation, rotational speed of the main spindle 10 and similar command.

The machine controller 20 outputs specific commands to the main spindle 10, the feed axis 12, the tool changer, and the like based on the input from the manual operation input unit M to control them. For example, the machine controller 20 outputs a corresponding command to the feed axis 12 based on the input from the manual feed button, the pulse handle, or the like included in the manual operation input unit M for operating the feed axis 12. Further, the machine controller 20 outputs a corresponding command to the main spindle 10 based on the input from the spindle normal rotation button, the spindle reverse rotation button, the spindle stop button, or the like included in the manual operation input unit M for operating the main spindle 10. Furthermore, the machine controller 20 outputs a tool change command to the tool changer based on the input from a tool change button or the like included in the manual operation input unit M for operating the tool change. In the case of the manual operation, an operator of the machine tool 1 uses the manual operation input unit M to change the tool, to control the main spindle 10 and the feed axis 12, to rotate the main spindle 10 at any rotational speed, to move the feed axis 12, and to perform cutting/removing, that is, machining of the material with the tool, via the machine controller 20.

In the case where the machine controller 20 issues the command to the feed axis 12 based on the input to the manual operation input unit M (the manual feed button and the like), the machine controller 20 interprets the input to the manual operation input unit M and outputs a command position divided for each control cycle to the feed axis 12 for each control cycle. In the case where the machine controller 20 issues the command to the main spindle 10 based on the input to the manual operation input unit M (the spindle normal rotation button and the like), the machine controller 20 similarly interprets the input to the manual operation input unit M and outputs the rotation command to the main spindle 10.

The command log data acquisition unit 22 sequentially acquires the commands generated by interpreting the block of the machining program P or interpreting the input from the manual operation input unit M at specific time points (here, every time when a new command is output) associating with time. Data that includes the acquired commands aligned in the state of being associated with time is defined as command log data. For example, the position command, the rotation command, the tool change command, a tool number in use, a starting command of the machining program P, a position of the block in execution in the machining program P (for example, the number of lines from the top), and manual operation information of the manual operation input unit M and the like are sequentially acquired as the command log data with the times where the commands and the like were executed. The manual operation information of the manual operation input unit M includes, for example, whether or not the manual feed button has been pressed and whether or not the spindle normal rotation button has been pressed.

The NC device 2 acquires the command log data as command information of the machine tool 1 in addition to performing control of the machine tool 1. An information acquisition device acquires the command log data may be disposed as a separate body.

The machining simulation apparatus 4 is, here, a PC (a personal computer) that executes a machining simulation application, and includes a log data storage unit 30, a log data display unit 32, a machining simulation data storage unit 34, a simulation range specification unit 36, a machining simulation execution unit 38, and a machining simulation display unit 40.

The log data storage unit 30 is communicatively connected to the command log data acquisition unit 22 of the NC device 2, and sequentially receives and stores the command log data. The log data storage unit 30 may be configured to be included in the NC device 2 and directly acquire the command log data.

The log data storage unit 30 is communicatively connected to the rotational speed detector 16, the position detector 18, and the temperature sensor 14 of the machine tool 1. The log data storage unit 30 sequentially receives and stores the rotational speed of the main spindle 10, a position detection value of the feed axis 12, the temperature of the temperature sensor 14 at any time points (here, for each specific acquisition cycle) in the state of being associated with time. Data that includes these detected values (machine status information indicating a status of the machine tool 1) aligned while being associated with time is status log data.

The above-described acquisition cycle and control cycle may be mutually identical or different. The time points of receiving and storing the rotational speed, the position detection value, and the temperature may be configured to be mutually different. Any of receiving and storing the rotational speed, the position detection value, and the temperature may be omitted. The machine tool 1 may include a status log data acquisition unit that acquires the rotational speed, the position detection value, and the temperature. The log data storage unit 30 may receive the rotational speed, the position detection value, and the temperature from this status log data acquisition unit. The status log data acquisition unit and the command log data acquisition unit 22 may be configured as a common log data acquisition unit in the NC device 2 or the machine tool 1. Alternatively, the NC device 2 may omit the command log data acquisition unit 22 such that the log data storage unit 30 receives the command log data from the machine controller 20.

The status log data includes a spindle load of the main spindle 10 and a feed axis load of the feed axis 12 (corresponding to torque commands to the servomotors of the respective axes). However, at least any of these loads may be omitted.

The log data display unit 32 displays a part of or the whole of at least one of the command log data and the status log data based on the input of log data display operation by input means (not illustrated) such as a keyboard and a pointing device.

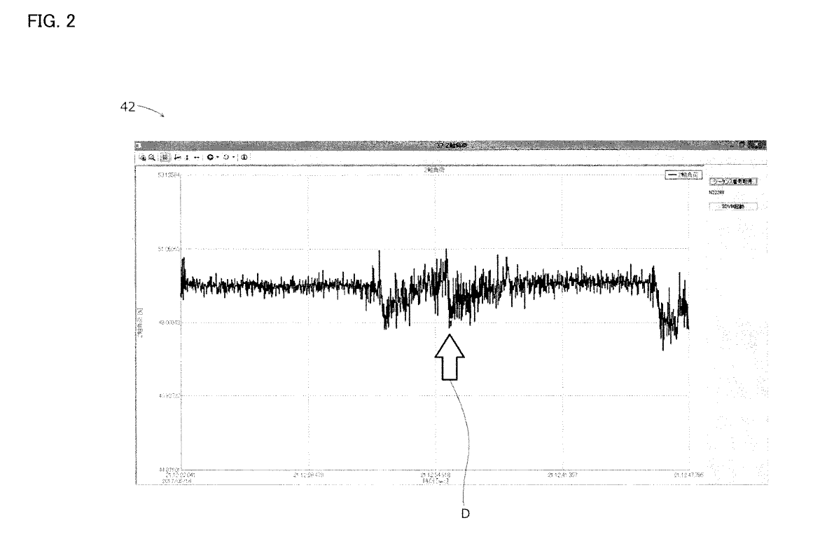

The log data display unit 32 displays a machine status information display window 42 as illustrated in FIG. 2. The machine status information display window 42 displays, here, a graph having a vertical axis indicating a Z-axis load value and a horizontal axis indicating a time.

The machine status information display window 42 may display a graph of a load value according to another axis, the temperature, the rotational speed of the main spindle 10, the time of the tool change, a tool number, and a start time of the machining program P, or a combination of these factors instead of the Z-axis load value or together with the Z-axis load value.

The machining simulation data storage unit 34 stores information on a tool model that imitates the tool, a material model that imitates the workpiece (the material) before the machining or during the machining, and a machine model that imitates the machine tool 1, and the information is used for the machining simulation. The tool model includes three-dimensional shape data on the tool and the tool number as a tool identification code that indicates a type of the tool, according to each of a plurality of kinds of the tools put on the tool changer. The three-dimensional shape data includes three-dimensional coordinates according to representative apexes and middle points of sides, and sizes and curvatures of planar surfaces and curved surfaces that constitute an outer surface, as necessary. The same applies to the other models. The material model includes the three-dimensional shape data on the material. The machine model includes the three-dimensional shape data on main constructions such as the main spindle 10 and the feed axis 12, data on mutual positional relationship, and data on moving mechanisms by the feed axis 12.

The various kinds of models are each preliminarily input by various methods. For example, the machine model is preliminarily input by a machine tool manufacturer, a tool model provided by the machine tool manufacturer among the tool models is preliminarily input by the machine tool manufacturer, and a tool model provided from the outside among the tool models and the material model are preliminarily input by a user with a three-dimensional shape input function embedded in a three-dimensional CAD (computer-aided design) application or a machining simulation application.

The simulation range specification unit 36 specifies a range in which the machining simulation is performed by the above-described input means.

The machining simulation execution unit 38 executes the following machining simulation corresponding to the range specified by the simulation range specification unit 36 with reference to the various models in the machining simulation data storage unit 34 and the log data stored in the log data storage unit 30 as necessary. That is, the machining simulation execution unit 38 changes the tool model according to the tool change command associated with time, and moves an axis configuration of the machine model according to the position command, thus cutting/removing of the material model with the tool model.

In the case of the machining by the machining program P, the machining simulation execution unit 38 indicates an execution point of the machining program P synchronized with the machining simulation according to the machining program P stored in the machining simulation data storage unit 34 and the position of the block in execution in the machining program P, the position being associated with time stored in the log data storage unit 30.

The machining simulation display unit 40 indicates a result obtained by the machining simulation execution unit 38.

The log data storage unit 30 and the machining simulation data storage unit 34 are achieved by storage means (for example, a hard disk and a memory) of a PC.

The machining simulation execution unit 38 is achieved by a CPU (a Central Processing Unit) of the PC.

The log data display unit 32 and the machining simulation display unit 40 are achieved by a monitor of the PC.

Such machining simulation apparatus 4 of the machine tool 1 operates as follows, for example.

The machining is performed by the machining program P or the manual operation in the machine tool 1. The log data from the start to the end of the machining (including an interruption) is accumulated in the log data storage unit 30. Then, the machining simulation is started. The machining simulation execution unit 38 displays at least one kind of the log data (for example, the log data of the load value of the main spindle 10) on the log data display unit 32, and accepts the range specification in the simulation range specification unit 36. The range can be specified by obtaining a time presenting the load value of an input as a specified time based on the input at a part, for example, indicated by an arrow D on a graph on the machine status information display window 42 displayed on the log data display unit 32. As the simulation range, both the start time and the end time may be specified, or any one may be specified to configure the simulation range as a range from a time corresponding to a beginning of the machining to a specified time, or a range from the specified time to a time corresponding to an end of the log data. It is not necessary to indicate the arrow D.

Next, the machining simulation execution unit 38 uses the log data in the log data storage unit 30 as the input in the range specified by the simulation range specification unit 36, and further refers to the various models in the machining simulation data storage unit 34, thus executing the machining simulation according to the machine tool 1. A time series in the machining simulation follows an order of the output time of the position command. This time series may be an order of the input time of the position command, an order of the output time of the position detection value, or similar order instead of the order of the output time of the position command.

The log data display unit 32 displays the log data (in the manual operation, the manual operation information is included) in the log data storage unit 30 corresponding to the range (the range of the time where the machining simulation is executed) specified by the simulation range specification unit 36.

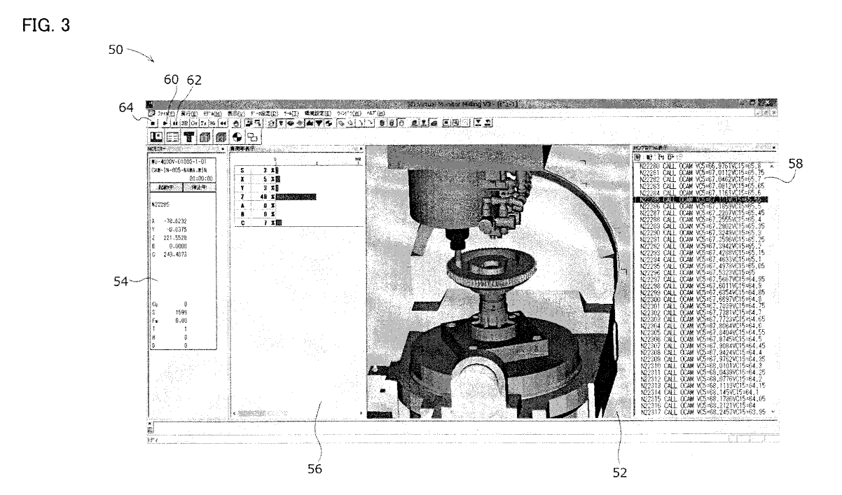

Subsequently, as illustrated in FIG. 3, the machining simulation execution unit 38 displays the result of the machining simulation on the machining simulation display unit 40.

The machining simulation display unit 40 displays a result display window 50 as illustrated in FIG. 3. The result display window 50 includes a model display portion 52 arranged at the center, an NC information display portion 54 arranged on a left side, a load factor display portion 56 arranged on a right side of the NC information display portion 54, and a command display portion 58 arranged on a right side.

The model display portion 52 displays a two-dimensional image imitating three-dimension according to the various models and the log data when the block (in the machining by the machining program) or the command (in the machining by the machining program or in the machining by the manual operation) on the predetermined time is executed. For example, the machining simulation execution unit 38 linearly moves the model (for example, three-dimensional coordinate values of respective apexes) of the main spindle 10 to the position corresponding to the values of the position command of the X-axis in a virtual three-dimensional space, thus converting the model into a two-dimensional image to display it on the model display portion 52. Similarly, the machining simulation execution unit 38 rotatably moves the model of the table on which the material model is put to the position corresponding to the values of the position command of the B-axis, thus displaying the model as an image. Alternatively, when the tool model contacts or overlaps the material model, the machining simulation execution unit 38 virtually cuts/removes the material model in the virtual three-dimensional space corresponding to the rotational speed of the main spindle 10 indicated by the log data, thus converting the material model including the state into an image and display the image. The machining simulation execution unit 38 controls the relative position between the tool model and the material model, executes the machining (here, cutting/removing, cutting) of the material model with the tool model in the virtual three-dimensional space, and displays it as the two-dimensional image from a predetermined viewing point or in a predetermined viewing direction on the model display portion 52. The rotational speed of the main spindle 10 is not required in the machining simulation, and it is not necessary to use the rotational speed of the main spindle 10.

The machining simulation execution unit 38 can change the viewing point and the viewing direction of this image based on the input (for example, a drag of the pointing device) on the model display portion 52, and generate a new image by an operation such as a model calculation to display the new image. For example, the machining simulation execution unit 38 converts the three-dimensional coordinate value of the apex or the like into the position of the apex or the like in the two-dimensional image based on the calculated viewing point and the viewing direction.

The machining simulation execution unit 38 displays the images of the position command in the time series order, that is, displays a moving image based on the input to a play button 60 on an upper left side of the result display window 50, and pauses or stops the moving image display based on the input to a pause button 62 or a stop button 64. In this image (various kinds of the models), mutually different colors may be given to respective elements such as the main spindle 10, the tool, the cutting edge, the material (the workpiece), a pallet, a turntable, and the table, or respective main parts of the elements.

The NC information display portion 54 displays, for example, a sequence number (in the machining by the machining program) or the command time (in the machining by the machining program or in the machining by the manual operation) corresponding to the image (model) that is displayed on the model display portion 52, the command values of the respective feed axes 12, and the rotational speed (spindle rotational speed) of the main spindle 10.

The load factor display portion 56 displays load factors of the respective axes according to the command time of the display target. The load factors are values (%) obtained by dividing the load values of the respective axes by rated loads of the respective axes and multiplying by 100. “S” indicates a load value (a spindle load value) of the main spindle 10, and the others indicate the load values of the respective feed axes 12. The spindle load value and the load values of the respective axes (in the machining by the machining program or in the machining by the manual operation), and the sequence number (in the machining by the machining program) correspond to the machine status information.

In the case of the machining by the machining program P, the command display portion 58 displays a part of or the whole of the machining program P including the block in execution and the blocks before and after the block in execution, and the block in execution is highlighted.

The machining simulation execution unit 38 may change the display on the model display portion 52 and the like based on the input to the command display portion 58. That is, the machining simulation execution unit 38 may have the model display portion 52 display the image corresponding to the block and similar image based on the input to any line of the command display portion 58. The result display window 50 and the machine status information display window 42 are configured to be simultaneously displayed side by side, or displayed in a state of being partially superimposed. The result display window 50 may display the machine status information. Conversely, the machine status information display window 42 may display the command value.

On the other hand, in the case of the machining by the manual operation, the command display portion 58 displays a manual operation history. The manual operation history indicates a variation of the manual operation information in a message format. The variation is displayed as, for example, “pressing spindle normal rotation button” or “pressing X-axis manual feed button.” In this display, an executed part in the manual operation history is highlighted in accordance with the time of the log data referred in the machining simulation.

When a manual interrupt is performed to interpose a manual machine operation in the middle of the machining by the machining program P, the command display portion 58 displays at least one of the block in execution at a currently referred time and the manual operation history.

The above-described machining simulation apparatus 4 performs the machining simulation in the machine tool 1 by controlling the relative position between the tool model and the material model to perform the machining of the material model with the tool model. The machining simulation is performed with the input of at least one of the position command and the position detection value obtained from the machine tool 1 as the log data corresponding to the time, and the result is displayed. Accordingly, the machining simulation apparatus 4 reproduces a past actual operating state of the machine tool 1. For example, even when the operator performed the manual operation such as an override change of the main spindle 10 and the feed axis 12 at the past actual machining, an accurate machining simulation reflecting this operation is ensured. The position detection value obtained as the log data is verifiable in the machining simulation. Such verification ensures verifying an influence on a machining shape due to a tracking error as a difference between the position command and the position detection value in the machine tool 1. In addition, even in the case where the operator performed the machining with the manual operation using the manual operation input unit M such as the manual feed button, the machining simulation is executable.

Further, the load value of the main spindle 10, the load value of the feed axis 12, the rotational speed of the main spindle 10, and the sequence number of the machining program P, which are obtained from the machine tool 1 as the log data corresponding to the time, are displayed together. Accordingly, the operator can refer to the spindle load value, the feed axis load value, the spindle rotational speed, and the sequence number of the machining program P simultaneously with the result display of the machining simulation, and grasping the operating state and a troubleshooting are further facilitated.

Furthermore, the log data is displayed in time series, and the range of the time for the machining simulation is specified based on the input to this display. Accordingly, the operator can easily specify a desired range as the target of the machining simulation.

In addition, at least one of the block of the machining program P and the manual operation history, which are corresponding to the machining simulation, is displayed together. Accordingly, the grasping the operating state and the troubleshooting are further more facilitated, for example, in the case where the load value of the main spindle 10 significantly varies even when the status of the cutting has not changed in the result display of the machining simulation, it is understood that this machining has caused a failure such as a breakage of the tool.

The machining simulation apparatus of the machine tool according to the disclosure is not limited to the aspect of the above described embodiment, and can be modified as necessary without departing from the spirit of the disclosure.

For example, the machine tool 1 may be a machine tool other than the five-axis-control machining center, the machining by the machine tool 1 may be a machining other than the cutting.

The machining simulation apparatus 4 may store the log data on a plurality of the machine tools 1 and the NC devices 2 in the log data storage unit 30, and change the machining simulation for each configuration of the machine tools 1 and the NC devices 2 to perform the machining simulation. In this case, the machining simulation data storage unit 34 stores the machine models, the tool models, the material models, jig models, and similar models necessary for performing the machining simulations of the plurality of the machine tools 1. Further, the machining simulation execution unit 38 selects and refers to the machine model and similar model necessary for the verification corresponding to the target log data.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

What is claimed is:

1. A machining simulation apparatus that performs a machining simulation in a machine tool by controlling a relative position between a tool model and a material model to perform a machining of the material model with the tool model, wherein
the machining simulation is performed with an input of at least one of a position command and a position detection value, the position command and the position detection value are obtained from the machine tool as log data corresponding to a time, and a result of the machining simulation is displayed.

2. The machining simulation apparatus according to claim 1, wherein
at least any of a spindle load value, a feed axis load value, a spindle rotational speed, a temperature, a tool number, a sequence number of a machining program, and a starting command of the machining program obtained from the machine tool as the log data corresponding to the time is displayed.

3. The machining simulation apparatus according to claim 1, wherein
the log data is displayed in time series, and a range of a time for the machining simulation is specified based on an input to the display.

4. The machining simulation apparatus according to claim 1, wherein
at least one of a block of the machining program and a manual operation history corresponding to the machining simulation is displayed together.
